(19) United States
(12) Patent Application Publication
(10) Pub. No.: US 2001/0053436 A1
(43) Pub. Date: Dec. 20, 2001

(54) Double layered film coated tape for tape rule

(76) Inventor: Shih Lin Li, Taipei (TW)

Correspondence Address: Keith Kline, 20775 Norada Court, Saratoga, CA, 95070, US

(21) Appl. No.: 09/934,731

(22) Filed: Aug. 21, 2001

Related U.S. Application Data
(63) Continuation-in-part of application No. 09/330,364, filed on Jun. 11, 1999.

(51) Int. Cl. B32B 15/08

(52) U.S. Cl. 428/203; 428/458; 428/480; 428/209

(57) ABSTRACT

A double layered film coated tape for tape rule disclosed herein is coated with a colored polyester layer serving as a base coat, and a transparent polyester layer serving as a protective layer for tape graduations, both formed on two tape surfaces, with this construction, anti-abrasive ability of the tape is enhanced, and the tape is made to have proper stiffness and flexibility with a minimum production cost.

### This application is a continuation-in-part of my copending application Ser. No. 09/330,364 filed Jun. 11, 1999.

### BACKGROUND OF THE INVENTION

1. Field of the Invention

The present invention related to a double layered film coated tape for tape rule, in particular, to a tape coated with two layered film so as to enhance its anti-abrasive property and make finished surface of the tape flatter and good looking with a simple fabrication process and a minimum production cost.

2. Description of the Prior Art

FIG. 1 shows a fundamental flow chart illustrating a conventional method of fabricating a tape for tape rule, the fabrication steps are:

1. preparing a roll of original colored metallic tape 11;

2. forming a base coat layer by adhering aluminum foil or baking paint on both tape surfaces 12;

3. printing graduations on the tape which already having being finished base coating 13;

4. coating with a polyester film 14 on both tape surfaces after printing graduations 13;

5. trimming and burling flashes of the aluminum foil and the polyester film 15; and

6. finishing a tape product 16.

In the conventional fabricating method generally adopted by manufactures, it has to pay particular attention that in the step 2 where a paint is used. As it is a well known fact, any colored painting materials usually contain poisonous chemicals with heavy metals and a stimulating order not only harmful to personnel in manufacturing workshops who constantly contact it, but also air polluting. The product made as such is possibly harmful and is by no means a good product.

In additional to complicated fabrication process, foams are likely to be generated between the aluminum foil and the polyester films due to snug bonding between aforesaid two layers thereby reducing yield of the product that leads to a waste of production cost. Besides, owing to rather large thickness of aluminum foil, the thickness of steel sheet used to form the main tape body must be reduced compensationally as thin as possible with the result that the finished tape product is in a state of low stiffness and flexibility as well.

Furthermore, no matter whether the base coat is formed of aluminum foil or of baked paint, both require a considerably high fabrication cost, as a result, users have to pay a higher price to purchase a tape rule whose tape is formed as such.

In order to overcome the shortcomings inherent to the conventional technique described above, the present inventor has delved into this matter with a long time efforts and come to realization of the present invention.

### SUMMARY OF THE INVENTION

It is an object of the present invention to provide a double layered film coated tape for tape rule in which a non-poisonous non-lead contained pigment is mixed with the polyester film used as base coat of the tape.

It is another object of the present invention to provide a double layered film coated tape for tape rule whose tape base coat is made by rolling so as to prevent air pollution in the vicinity.

It is still another object of the present invention to provide a double layered film coated tape having proper stiffness, flatness and flexibility for tape rule.

It is one more object of the present invention to provide a double layered film coated tape with a good color rendering, and easy for observing its graduations thereon when doing measurement.

The above mentioned objects and other advantages of the present invention can be achieved by providing a tape for tape rul comprising:

a thin tape body; colored polyester films formed on both tape surfaces; graduation layers formed on both colored polyester films, and a transparent polyester film formed on each graduation layer.

The colored polyester films serve as base coat for the tape, and necessary graduations are printed on the graduation layers formed on both polyester films, the transparent polyester film is formed on each graduation layer, such that the graduations are well protected from ablation by the transparent polyester films.

With this structure, the colored and transparent polyester films are formed on both tape surfaces, and the material for the colored polyester film is made by churning the resultant mixture of polyester plus a pigment and a binder so as to exhibit a specified color.

### BRIEF DESCRIPTION OF THE DRAWINGS

The drawings disclose an illustrative embodiment of the present invention which serves to exemplify the various advantages and objects hereof, and are as follows:

FIG. 1 is a fundamental flow chart showing the steps of fabricating a tape for tape rule according to the conventional technique.

FIG. 2 is a fundamental flow chart showing the steps of fabricating a tape for tape rule according to the present invention.

FIG. 3 is a schematic view showing structure of a double layered film coated tape for tape rule according to the present invention.

### DETAILED DESCRIPTION OF THE PREFERRED EMBODIMENT

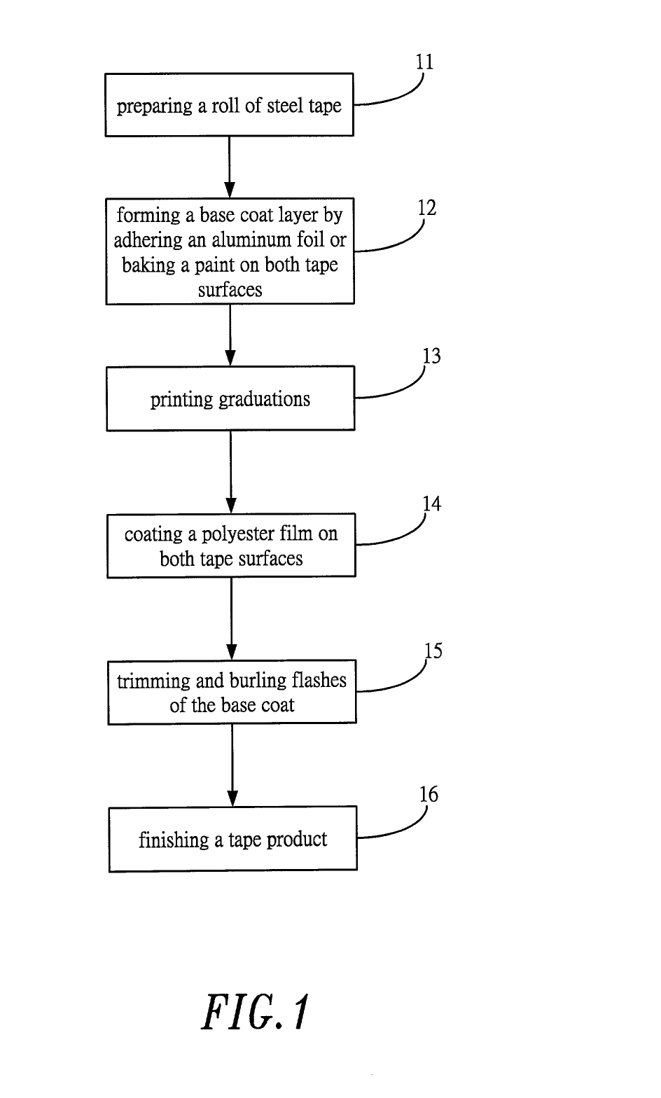

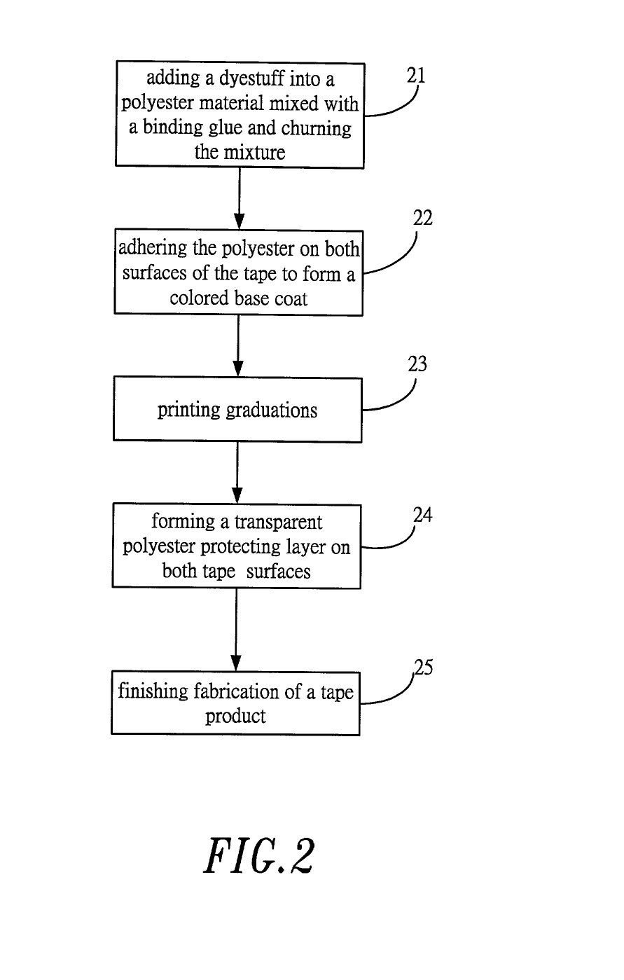

FIG. 1 and 2 are fundamental flow charts showing the steps of fabricating a tape for tape rule according to the conventional technique (FIG. 1) and the present invention (FIG. 2) respectively. As shown in FIG. 2, the fabrication process of the present invention include the steps:

1. adding a pigment or a dyestuff into a polyester material mixed with a binding glue and churning the mixture so as to exhibit a specified color 21;

2. adhering the colored polyester material prepared in step 1 by rolling with a roller which is maintained at a constant temperature of 150° C., to both surfaces of a steel tape (in original metallic color) so as to form colored base coat on the steel tape, and preventing foams from being produced between the tape surfaces and the polyester base coat so as to maintain the tape in flat state, and then winding up the tape after being finished base coating around a reel 22;

3. printing graduations on both surfaces of the steel tape treated with base coating in step 2, and then drying the tape by infrared ray 23;

4. rolling a mixture of a transparent polyester and a binding glue with a roller maintained at a constant temperature of 150° C. on both surfaces of the tape after having being printed graduations in step 3, so as to form an anti-abrasive protecting layer 24 for the tape.

5. finishing fabrication of a double layered film coated tape for tape rule 25.

Meanwhile, the base coat formed in step 2 is non-poisonous and is in compliance with requirement of environment protection. In addition, the polyester film of the present invention either used as base coat or as a protecting layer can be formed thinner than the aluminum foil or the baked paint both formed by conventional technique, consequently, a thicker steel strip can be selected to form the tape body which results in upgrading stiffness and flexibility of the finished tape. As for the cost, the price of the polyester material used in the present invention is cheaper than the price of the base coat or aluminum foil used by the conventional technique, and naturally, manpower for carrying out base coating can be saved.

After comparing the two flow charts illustrated in FIGS. 1 and 2, it is obvious that the fabrication process according to the present invention is simpler than that conducted according to the conventional technique. For example, trimming and burling flashes of the base coat in step 15 of the conventional method is no more needed in the fabrication process of the present invention thus aiding to save the overall production cost.

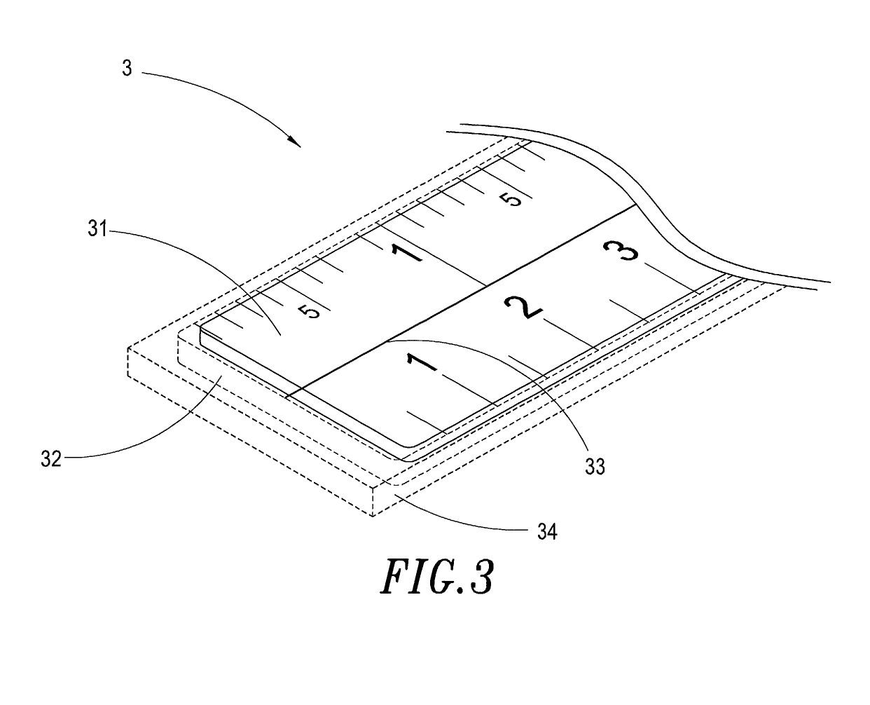

FIG. 3 is schematic view showing structure of a double layered film coated tape for tape rule according to the present invention. As shown in FIG. 3, the tape of the present invention comprises: a thin tape body 31; colored polyester films 32 on both tape surfaces; graduation layers 33 formed on both colored polyester films 32; and a transparent polyester film 34 formed on each graduation layer 33.

The colored polyester films 32 serve as base coating for the tape, and necessary graduations are printed on graduation layers 33 formed on both polyester films 32, the transparent film 34 is formed on each graduation layer 33 such that the graduations are well protected by anti-abrasive transparent polyester films 34. With this structure, the colored and transparent polyester films 32 and 34 are formed on both tape surfaces and the material for the colored polyester film 32 is prepared by churning the resultant mixture of polyester plus a pigment and binder so as to obtain a specified color.

In summary, the present invention is superior to any other conventional technique by the following facts:

1. Non-poisonous pigment is added in the polyester material so that health of the tape rule usher is never affected by the base coat of the tape formed as such.

2. As the thickness of the colored polyester film is thinner than that of any conventional base coat, consequently, a thicker steel sheet may be selected for use as a tape body which helps to upgrade stiffness and flexibility of the finished tape.

3. The price of polyester material used in the present invention is less expensive than aluminum foil or baked base coat so that overall cost for fabricating a tape rule is greatly reduced.

4. The danger of electrostatic discharge can be avoided because polyester is non-metallic material.

Those who are skilled in the art will readily perceive how to modify the invention. Therefore, the appended claims are to be construed to cover all equivalent structures which fall within the true scope and sprit of the invention.

What is claimed is:

1. A double layered film coated tape for tape rule comprising:
a thin tape body;
colored polyester films formed on both tape surfaces;
graduation layers formed on said both colored polyester films; and
a transparent polyester film formed on each said graduation layer;
said colored polyester films serve as base coat for the tape, and necessary graduations are printed on said graduation layers, said transparent polyester film is formed on each graduation layer such that the graduations are well protected from abrasion by said transparent polyester films.

2. The tape of claim 1, wherein said colored and said transparent films are formed on both tape surfaces.

3. The tape of claim 1, wherein the material for said colored polyester film is prepared by churning the resultant mixture of polyester added with a pigment and a binder so as to exhibit a specified color.
